(19) United States
(12) Patent Application Publication
(10) Pub. No.: US 2008/0316458 A1
(43) Pub. Date: Dec. 25, 2008

(54) Light Quantity Adjustment Method, Image Recording Method, and Device

(75) Inventors: Katsuto Sumi, Kanagawa-ken (JP); Issei Suzuki, Kanagawa-ken (JP); Kazuteru Kowada, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/887,378

(22) PCT Filed: Mar. 28, 2006
(86) PCT No.: PCT/JP2006/306366

§ 371 Date: Dec. 31, 2007

(51) Int. Cl. G03B 27/72

(52) U.S. Cl. 355/69

(57) ABSTRACT

According to test data supplied from a test data memory (80), a test pattern is formed on a substrate (F) and its line width is measured. Light source units (28a to 28j) are adjusted by a light source control unit (89) and the line width change amount between exposure heads (24a to 24j) is corrected so as to set the obtained light quantity. In a mask data setting unit (86), mask data is set so as to control a particular micro mirror of DMD constituting the exposure heads (24a to 24j) to OFF state. By using the mask data, the output data is corrected and a desired image is exposed/recorded on a substrate (F).

### TECHNICAL FIELD

The present invention relates to an amount-of-light (light quantity) adjusting method, an image recording method, and an image recording apparatus (device) for controlling a plurality of exposure heads having independent light sources for outputting light beams and arrayed along an image recording medium, depending on image data, to record an image on the image recording medium.

### BACKGROUND ART

FIG. 27 is a view illustrative of a process of manufacturing a printed wiring board. A substrate 2 with a copper foil 1 deposited thereon by evaporation or the like is prepared. A photoresist 3 made of a photosensitive material is pressed with heat against (laminated on) the copper foil 1. After the photoresist 3 is exposed to light according to a wiring pattern by an exposure apparatus, the photoresist 3 is developed by a developing solution. Then, the portion of the photoresist 3 which has not been exposed is removed. The copper foil 1 that is exposed by the removal of the photoresist 3 is etched away by an etching solution. Thereafter, the remaining photoresist 3 is peeled off by a peeling solution. As a result, a printed wiring board having the copper foil 1 left in the desired wiring pattern on the substrate 2 is manufactured.

There is known an image recording apparatus for modulating light beams emitted from a plurality of light sources with image data and guiding the modulated light beams to a photosensitive material, as an apparatus for recording a wiring pattern on photoresist 3 by way of exposure. If the amounts of light of the light beams emitted from the light sources differ from each other, then an image recorded on the photosensitive material suffers irregularities. Therefore, the amounts of light of the light beams from the respective light sources are detected by photodetectors for adjustment.

However, since the photodetectors generally have different sensitivities with respect to wavelengths of light detected thereby, if the light beams emitted from the respective light sources have different wavelengths, then detected values of the amounts of light are also different from each other, failing to make correct adjustment. It has been proposed to detect amounts of light of light beams emitted from light sources while correcting the amounts of light depending on the wavelengths of the light beams (see Japanese Patent Publication No. 7-117447).

Generally, photosensitive materials for recording images thereon have different sensitivities with respect to the wavelengths of light beams applied thereto. Consequently, even if the amounts of light of the light beams are adjusted in view of the wavelength dependency of the photodetectors, there is no guarantee that images free of irregularities will necessarily be recorded. If the light beams have different beam diameters and are focused differently by an optical system, then the recorded image will suffer irregularities even when the image is recorded with the same amounts of light of the light beams.

### DISCLOSURE OF THE INVENTION

It is a general object of the present invention to provide an amount-of-light adjusting method, an image recording method, and an image recording apparatus which are capable of recording a desired image free of irregularities highly accurately on an image recording medium using a plurality of light sources.

A major object of the present invention is to provide an amount-of-light adjusting method, an image recording method, and an image recording apparatus which are capable of recording a desired image highly accurately by correcting localities of the amounts of light of light beams emitted from respective light sources.

Another object of the present invention is to provide an amount-of-light adjusting method, an image recording method, and an image recording apparatus which are capable of recording a desired image highly accurately by correcting irregularities caused by process in an image recording medium.

A further object of the present invention is to provide an amount-of-light adjusting method, an image recording method, and an image recording apparatus which are capable of recording a desired image highly accurately by correcting irregularities caused by sensitivity characteristics of an image recording medium.

### BRIEF DESCRIPTION OF THE DRAWINGS

FIG. 1 is an external perspective view of an exposure apparatus according to an embodiment of the present invention;

FIG. 2 is a schematic view of an exposure head of the exposure apparatus according to the embodiment;

FIG. 3 is an enlarged fragmentary view showing a DMD employed in the exposure head shown in FIG. 2;

FIG. 4 is a view illustrative of an exposure recording process performed by the exposure head shown in FIG. 2;

FIG. 5 is a diagram showing the DMD of the exposure head shown in FIG. 2 and mask data set in the DMD;

FIG. 6 is a diagram showing the relationship between a recording position and an amount-of-light locality in the exposure apparatus according to the embodiment;

FIG. 7 is a diagram showing a line width recorded when the amount-of-light locality shown in FIG. 6 is not corrected;

FIG. 8 is a diagram showing a line width recorded when the amount-of-light locality shown in FIG. 6 is corrected;

FIG. 9 is a block diagram of a control circuit of the exposure apparatus according to the embodiment;

FIG. 10 is a flowchart of an amount-of-light correcting process and an image exposing process which are performed by the exposure apparatus according to the embodiment;

FIG. 11 is a diagram showing a test pattern recorded on a substrate by the exposure apparatus according to the embodiment;

FIG. 12 is a diagram showing the relationship between the position of the test pattern shown in FIG. 11 and measured line widths of respective exposure heads;

FIG. 13 is a diagram showing the relationships between amounts of change in the amount of light of a laser beam applied to the substrate and corresponding amounts of change in line widths;

FIG. 14 is a diagram illustrative of a halftone dot pattern recorded on a substrate by the exposure apparatus according to the embodiment;

FIG. 15 is a diagram illustrative of grayscale data as test data;

FIG. 16 is a diagram illustrative of a copper foil pattern formed on a substrate using the grayscale data shown in FIG. 15;

FIG. 17 is a diagram showing another test pattern recorded on a substrate by the exposure apparatus according to the embodiment;

FIG. 18 is a view showing an edge area formed along a direction in which a substrate is scanned;

FIG. 19 is a view showing an edge area formed along a direction perpendicular to a direction in which a substrate is scanned;

FIG. 20 is a diagram showing the relationship between amounts of change in the amount of light and in line width on photosensitive materials of different types;

FIG. 21 is a diagram showing the relationship between the position of the substrate and the line width on photosensitive materials of different types;

FIG. 22 is a diagram showing the relationship between the position of the substrate and the amount-of-light correction variables on photosensitive materials of different types;

FIG. 23 is a diagram showing spectral sensitivity characteristics of photosensitive materials;

FIG. 24 is a block diagram of a control circuit according to another embodiment;

FIG. 25 is a diagram showing the relationship between beam diameters and line widths;

FIG. 26 is a block diagram of a control circuit according to still another embodiment; and

FIG. 27 is a view illustrative of a process of manufacturing a printed wiring board.

### BEST MODE FOR CARRYING OUT THE INVENTION

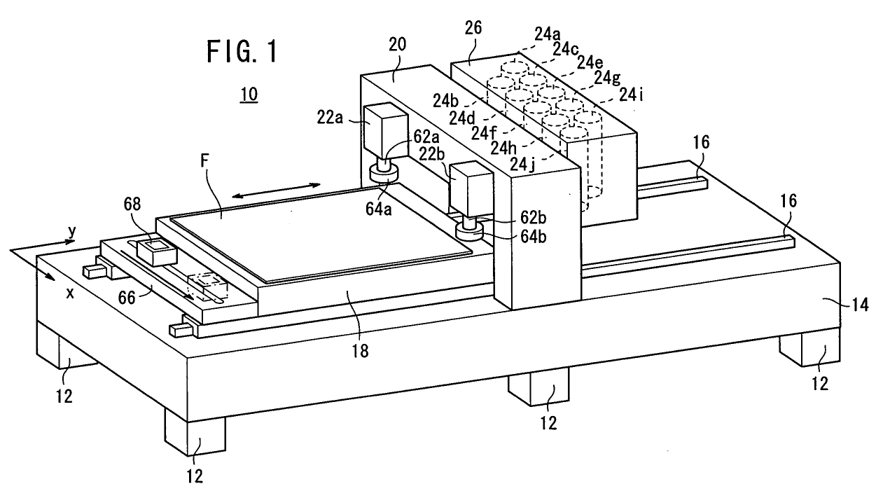

FIG. 1 shows an exposure apparatus 10 for performing an exposure process on a printed wiring board, etc., to which an amount-of-light adjusting method, an image recording method, and an image recording apparatus according to an embodiment of the present invention are applied. The exposure apparatus 10 has a bed 14, which suffers very little deformations, supported by a plurality of legs 12, and an exposure stage 18 mounted on the bed 14 by two guide rails 16 for reciprocating movement in the directions indicated by the arrow. An elongate rectangular substrate F (mage recording medium) coated with a photosensitive material is attracted to and held on the exposure stage 18.

A portal column 20 is mounted centrally on the bed 14 over the guide rails 16. Two CCD cameras 22a, 22b are fixed to one side of the column 20 for detecting the position in which the substrate F is mounted with respect to the exposure stage 18. A scanner 26 having a plurality of exposure heads 24a through 24j positioned and held therein for recording an image on the substrate F by way of exposure is fixed to the other side of the column 20. The exposure heads 24a through 24j are arranged in two staggered rows in a direction perpendicular to the directions in which the substrate F is scanned (the directions in which the exposure stage 18 is movable). Flash lamps 64a, 64b are mounted on the CCD cameras 22a, 22b, respectively, by respective rod lenses 62a, 62b. The flash lamps 64a, 64b apply an infrared radiation to which the substrate F is insensitive, as illuminating light, to an image capturing area for the CCD cameras 22a, 22b.

A guide table 66 which extends in the direction perpendicular to the directions in which the exposure stage 18 is movable is mounted on an end of the bed 14. The guide table 66 supports thereon a photosensor 68 movable in the direction indicated by the arrow x for detecting the amount of light of laser beams L emitted from the exposure heads 24a through 24j.

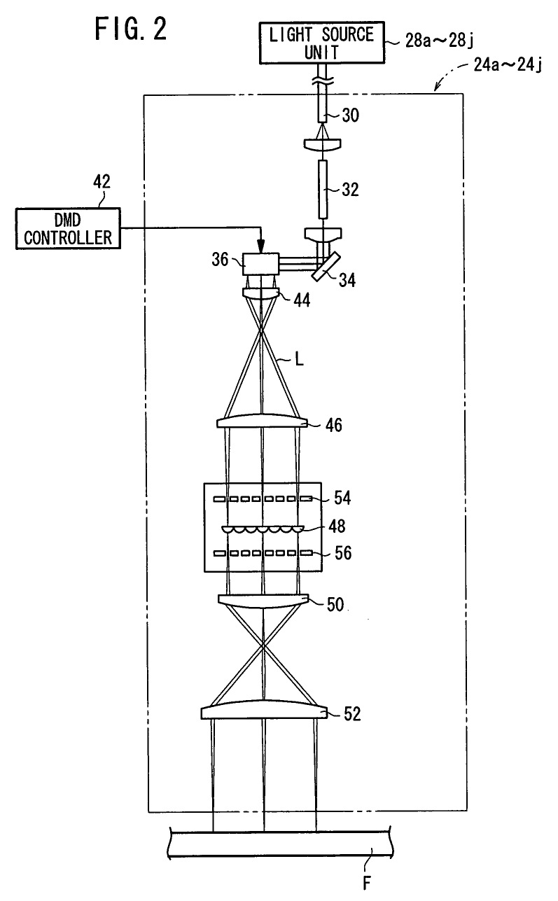

FIG. 2 shows a structure of each of the exposure heads 24a through 24j. A combined laser beam L emitted from a plurality of semiconductor lasers (light sources) of light source units 28a through 28j is introduced through an optical fiber 30 into each of the exposure heads 24a through 24j. A rod lens 32, a reflecting mirror 34, and a digital micromirror device (DMD) 36 are successively arranged on an exit end of the optical fiber 30 into which the laser beam L is introduced.

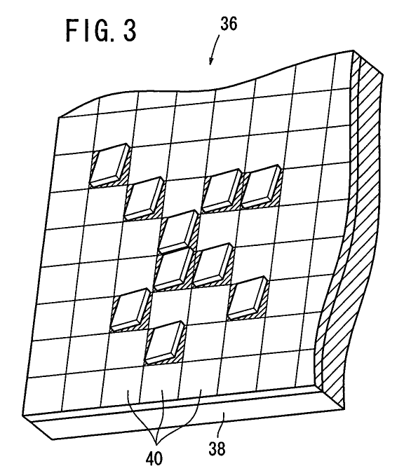

As shown in FIG. 3, the DMD 36 (spatial light modulator) comprises a number of micromirrors 40 (spatial light modulating elements) that are swingably disposed in a matrix pattern on SRAM cells (memory cells) 38. A material having a high reflectance such as aluminum or the like is evaporated on the surface of each of the micromirrors 40. When a digital signal according to image recording data is written in the SRAM cells 38 by a DMD controller 42, the micromirrors 40 are tilted in given directions depending on the applied digital signal. Depending on how the micromirrors 40 are tilted, the laser beam L is turned on or off.

In the direction in which the laser beam L reflected by the DMD 36 that is controlled to be turned on or off is emitted, there are successively disposed first image focusing optical lenses 44, 46 of a magnifying optical system, a microlens array 48 having may lenses corresponding to the respective micromirrors 40 of the DMD 36, and second image focusing optical lenses 50, 52 of a zooming optical system. Microaperture arrays 54, 56 for removing stray light and adjusting the laser beam L to a predetermined diameter are disposed in front of and behind the microlens array 48.

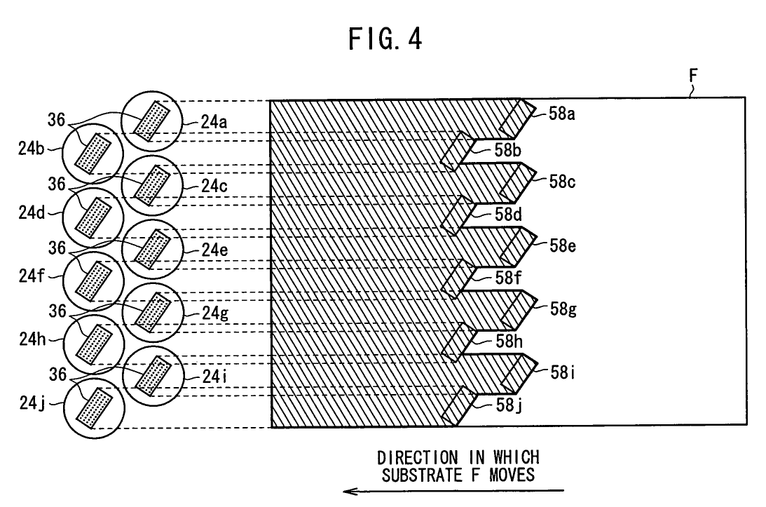

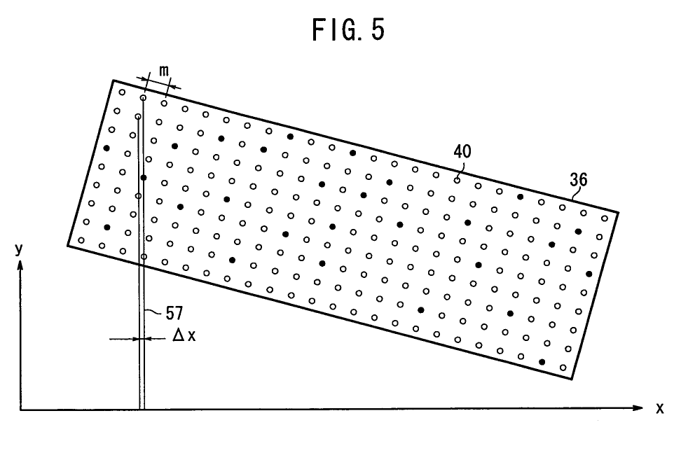

As shown in FIGS. 4 and 5, the DMDs 36 incorporated in the respective exposure heads 24a through 24j are inclined a predetermined angle to the direction in which the exposure heads 24a through 24j move, for achieving higher resolution. Specifically, the DMDs 36 that are inclined to the direction in which the substrate F is scanned (the direction indicated by the arrow y) reduce the interval Δx between the micromirrors 40 in the direction (the direction indicated by the arrow x) perpendicular to the direction in which the substrate F is scanned, to a value smaller than the interval m between the micromirrors 40 of the DMDs 36 in the direction in which they are arrayed, thereby increasing the resolution.

In FIG. 5, a plurality of micromirrors 40 are disposed on one scanning line 57 in the scanning direction (the direction indicated by the arrow y) of the DMDs 36. The substrate F is exposed to a multiplicity of images of one pixel by laser beams L that are guided to substantially the same position by these micromirrors 40. In this manner, amount-of-light irregularities between the micromirrors 40 can be averaged. To make the exposure heads 24a through 24j seamless, they are arranged such that exposure areas 58a through 58j which are exposed at a time by the respective exposure heads 24a through 24j overlap in the direction indicated by arrow x.

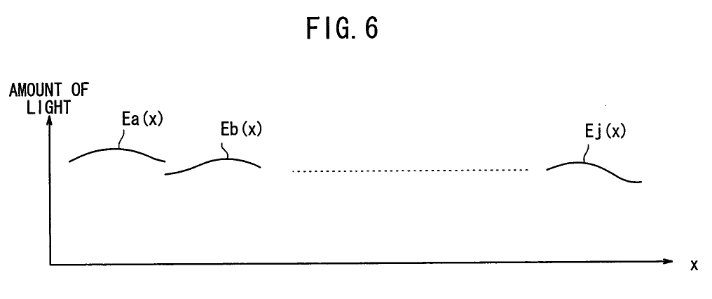

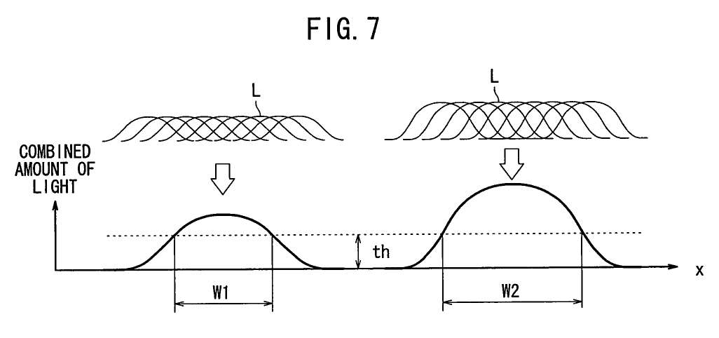

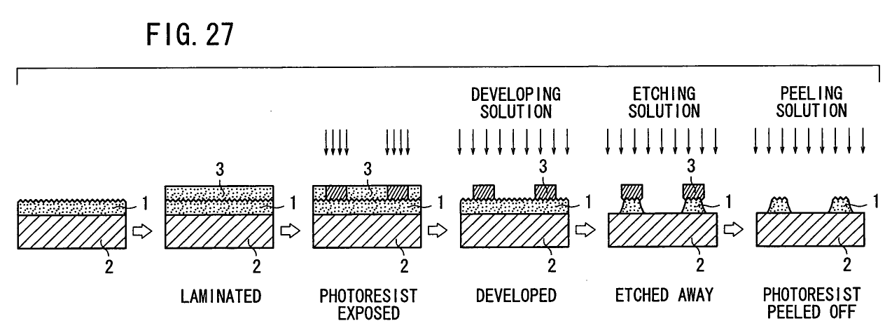

The amounts Ea(x) through Ej(x) of the laser beams L output from the light source units 28a through 28j and guided from the exposure heads 24a through 24j to the substrate F are different from each other prior to adjustment, as shown in FIG. 6. The amount of light of the laser beam L that is guided to the substrate F by each of the micromirrors 40 of the DMDs 36 of the exposure heads 24a through 24j has a locality caused by the reflectance of the DMDs 36, the optical system, etc. along the direction indicated by the arrow x in which the exposure heads 24a through 24j are arrayed. With such amount-of-light irregularities, as shown in FIG. 7, when an image is recorded on the substrate F by laser beams L having a smaller combined amount of light which are reflected by a plurality of micromirrors 40 and when an image is recorded on the substrate F by laser beams L having a greater combined amount of light which are reflected by the micromirrors 40, the recorded images have respective different widths W1, W2 in the direction indicated by the arrow x as a threshold th beyond which the photosensitive material applied to the substrate F is sensitive in a predetermined state. When the exposed substrate F is processed by a developing process, an etching process, and a peeling process, as shown in FIG. 27, the widths of the images are also varied by photoresist lamination irregularities, developing process irregularities, etching process irregularities, and peeling process irregularities as well as the amount-of-light irregularities of the laser beams L.

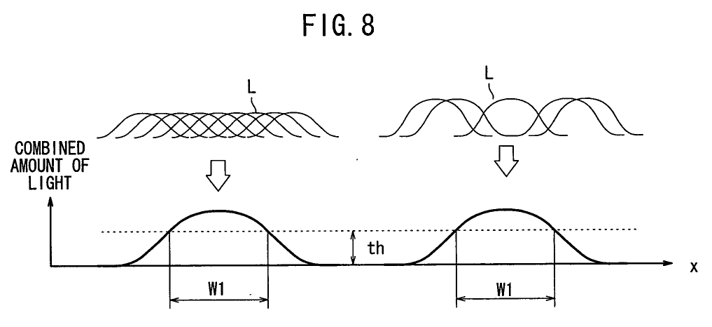

According to the present embodiment, in view of the above various factors responsible for the variations, the amounts of light of the laser beams L output from the light source units 28a through 28j are corrected, and the number of micromirrors 40 that are used to form one pixel of image on the substrate F is set using mask data to control images to have a constant width W1 regardless of the positions in the direction indicated by the arrow x taking the various processes to the final peeling process into consideration, as shown in FIG. 8.

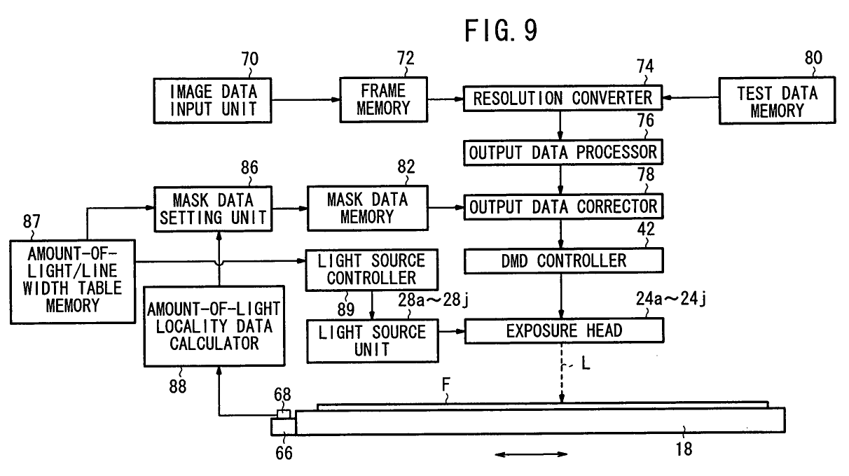

FIG. 9 shows in block form a control circuit of the exposure apparatus 10 having a function to perform such a control process.

The exposure apparatus 10 has an image data input unit 70 for entering image data to be recorded on the substrate F by exposure, a frame memory 72 for storing the two-dimensional image data, a resolution converter 74 for converting the resolution of the image data stored in the frame memory 72 into a higher resolution depending on the size and layout of the micromirrors 4 of the DMDs 36 of the exposure heads 24a through 24j, an output data processor 76 for processing the resolution-converted image data into output data to be assigned to the micromirrors 40, an output data corrector 78 (second amount-of-light correcting means) for correcting the output data according to mask data, a DMD controller 42 (exposure head control means) for controlling the DMDs 36 according to the corrected output data, and the exposure heads 24a through 24j for recording a desired image on the substrate F with the DMDs 36 that are controlled by the DMD controller 42.

A test data memory 80 (test data storage means) for storing test data is connected to the resolution converter 74. The test data are data for recording by exposure a test pattern, which comprises a repetition of constant line widths and constant space widths, on the substrate F, and generating mask data based on the test pattern.

A mask data memory 82 for storing mask data is connected to the output data corrector 78. The mask data are data for specifying micromirrors 40 to be turned off at all times, thereby correcting image localities due to the exposure heads 24a through 24j. The mask data are set by a mask data setting unit 86. The exposure apparatus 10 also has an amount-of-light locality data calculator 88 for calculating amount-of-light locality data based on the amounts of light of the laser beams L detected by the photosensor 68. The amount-of-light locality data calculated by the amount-of-light locality data calculator 88 are supplied to the mask data setting unit 86.

The mask data setting unit 86 sets mask data using a table representative of the relationship between amounts of change in line widths (recorded state) of the test pattern and amounts of change in amounts of light of the laser beams L with respect to the amounts of change in line widths, which table is stored in an amount-of-light/line width table memory 87 (recorded state/amount-of-light storage means). A light source controller 89 (amount-of-light correcting means) corrects the amounts of light of the laser beams L output from the light source units 28a through 28j, using the relationship stored in the amount-of-light/line width table memory 87.

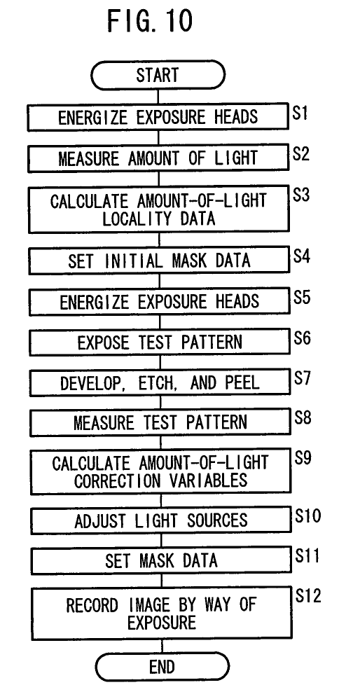

The exposure apparatus 10 according to the present embodiment is basically constructed as described above. A process of correcting the amounts of light of the laser beams L and recording a desired image on the substrate F by way of exposure will be described below with reference to a flowchart shown in FIG. 10.

First, the exposure stage 18 is moved to place the photosensor 68 beneath the exposure heads 24a through 24j. Thereafter, the exposure heads 24a through 24j are energized (step S1). At this time, the DMD controller 42 sets all the micromirrors 40 of the DMDs 36 to an on-state for guiding the laser beams L to the photosensor 68.

While moving in the direction indicated by the arrow x in FIG. 1, the photosensor 68 measures the amounts of light of the laser beams L emitted from the exposure heads 24a through 24j, and supplies the measured amounts of light to the amount-of-light locality data calculator 88 (step S2). Based on the amounts of light measured by the photosensor 68, the amount-of-light locality data calculator 88 calculates amount-of-light locality data of the laser beam L at each position x in the direction indicated by the arrow x, and supplies the calculated amount-of-light locality data to the mask data setting unit 86 (step S3).

Based on the supplied amount-of-light locality data, the mask data setting unit 86 generates initial mask data for making constant the amounts Ea(x) through Ej(x) of light of the laser beams L at respective positions x on the substrate F, and stores the initial mask data in the mask data memory 82 (step S4). The initial mask data are established as data for controlling some of a plurality of micromirrors 40 for forming one image pixel at each position x on the substrate F, into an off-state according to the amount-of-light locality data in order to eliminate the locality of the amounts Ea(x) through Ej(x) of light shown in FIG. 6, for example. In FIG. 5, those micromirrors 40 that have been set to the off-state by the initial mask data are illustrated as black dots.

After the initial mask data have been established, the exposure stage 18 is moved to place the substrate F beneath the exposure heads 24a through 24j, and the exposure heads 24a through 24j are energized based on test data (step S5).

The resolution converter 74 reads test data from the test data memory 80, converts the resolution of the test data into a resolution corresponding to the micromirrors 40 of the DMDs 36, and supplies the resolution-converted test data to the output data processor 76. The output data processor 76 processes the resolution-converted image data into test output data representing signals for selectively turning on and off the micromirrors 40, and supplies the test output data to the output data corrector 78. The output data corrector 78 forcibly turns off those test output data for the micromirrors 40 which correspond to the initial mask data supplied from the mask data memory 82, and then supplies the corrected test output data to the DMD controller 42.

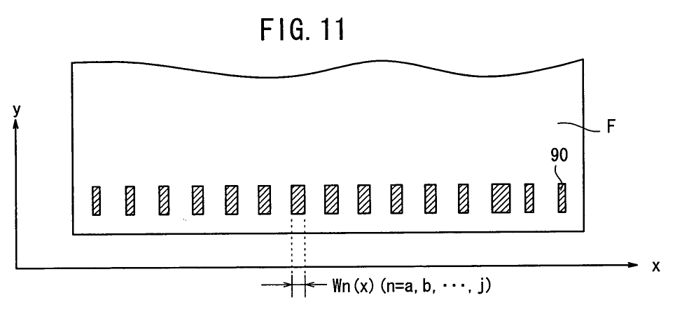

The DMD controller 42 selectively turns on and off the micromirrors 40 of the DMDs 36 according to the test output data that have been corrected by the initial mask data, thereby applying the laser beams L emitted from the light source units 28a through 28j to the substrate F to record a test pattern by exposure thereon (step S6). Since the test pattern is formed according to the test output data that have been corrected by the initial mask data, the test pattern is free of the amount-of-light locality of the laser beams L applied from the exposure heads 24a through 24j to the substrate F. The developing process, the etching process, and the resist peeling process are performed on the substrate F with the test pattern recorded thereon by exposure, producing the substrate F with the test pattern remaining thereon (step S7). As shown in FIG. 11, for example, the test pattern comprises a plurality of rectangular test patterns 90 formed at respective positions x spaced along the direction indicated by the arrow x and having line widths Wa(x) through Wj(x). In a locality-free ideal state, the test pattern is recorded based on test output data wherein the line widths Wa(x) through Wj(x) and space widths are constant regardless of the position x.

Inasmuch as the wavelengths, the beam diameters, the focused states, etc. of the laser beams L emitted from the light source units 28a through 28j and applied to the substrate F usually differ from each other, the line widths Wa(x) through Wj(x) or the space widths of the test patterns 90 may not be constant due to photosensitive characteristic differences depending on the wavelength of the photosensitive material applied to the substrate F and irregularities depending on the position x of the developing process, etc.

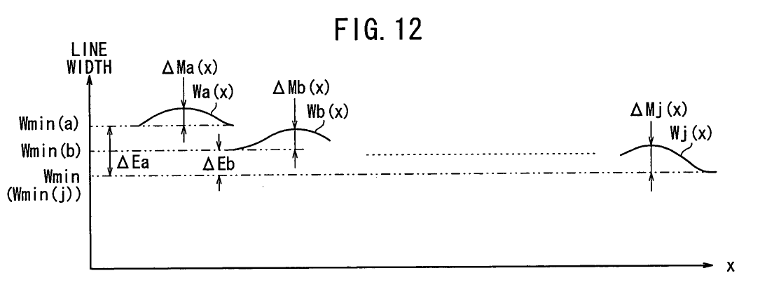

Accordingly, the line widths Wa(x) through Wj(x) of the test patterns 90 on the substrate F are measured with respect to the respective exposure heads 24a through 24j (step S8). Based on the measured result, the light source controller 89 calculates, with respect to the respective light source units 28a through 28j, as shown in FIG. 12, amount-of-light correction variables ΔEa through ΔEj for correcting minimum values Wmin(a) through Wmin(j) of the line widths Wa(x) through Wj(x) formed by the exposure heads 24a through 24j into a minimum line width Wmin of the minimum values Wmin(a) through Wmin(j) (step S9).

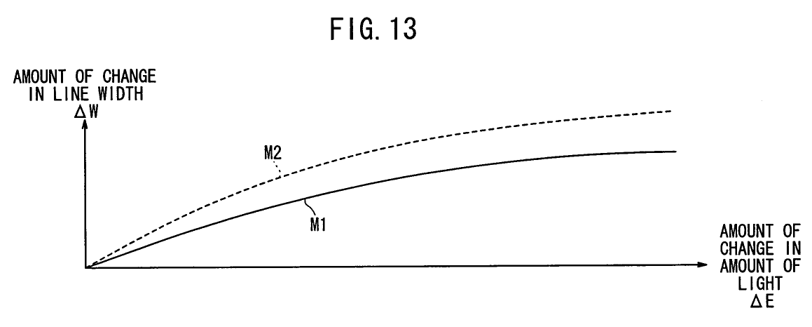

FIG. 13 shows the relationships M1, M2 between the amounts ΔE of change in the amounts of light of the laser beams L applied to the substrate F and corresponding amounts ΔW of change in the line widths. The relationships M1, M2 correspond to the types of photosensitive materials which may be applied to the substrate F, and are determined in advance by an experiment and stored in the amount-of-light/line width table memory 87. The light source controller 89 selects the relationship M1 or M2 depending on the type of the photosensitive material used from the amount-of-light/line width table memory 87, and calculates amounts ΔE of change in the amounts of light which are capable of obtaining amounts ΔW of change in the line widths for correcting the minimum values Wmin(a) through Wmin(j) of the line widths Wa(x) through Wj(x) into the line width Wmin, as amount-of-light correction variables ΔEa through ΔEj. The light source controller 89 then adjusts the amounts of light of the laser beams L output from the light source units 28a through 28j according to the calculated amount-of-light correction variables ΔEa through ΔEj (step

The mask data setting unit 86 calculates amount-of-light correction variables ΔMa(x) through ΔMj(x) (see FIG. 12) for correcting the line widths Wa(x) through Wj(x), which are different due to the locality of the amounts of light of the DMDs 36 of the exposure heads 24a through 24j, into the minimum values Wmin(a) through Wmin(j), using the amount-of-light/line width table memory 87, and adjusts the initial mask data set in step S4 based on the amount-of-light correction variables ΔMa(x) through ΔMj(x) thereby to setting mask data (step S11). The mask data are established as data for determining micromirrors 40 to be set to the off-state among the micromirrors 40 that are used to form one pixel of image at each position x on the substrate F, according to the amount-of-light correction variables ΔMa(x) through ΔMj(x). The established mask data are stored, in place of the initial mask data, in the mask data memory 82.

Using the proportion of the amount-of-light correction variables ΔMa(x) through ΔMj(x) to the amounts Ea(x) through Ej(x) (see FIG. 6) of light at the time the output data are corrected with the initial mask data, and the number N of micromirrors 40 for forming one pixel, the number n of micromirrors 40 to be set to the off-state is calculated by:

n=N·ΔMk(x)/Ek(x)(k:a to j)

The mask data are established to set the n micromirrors 40, among the N micromirrors 40, to the off-state.

After the mask data have thus been established, a desired wiring pattern is recorded by way of exposure on the substrate F (step S12).

First, image data representing a desired wiring pattern are entered from image data input unit 70. The entered image data are stored in the frame memory 72, and then supplied to the resolution converter 74. The resolution converter 74 converts the resolution of the image data into a resolution depending on the resolution of the DMDs 36, and supplies the resolution-converted image data to the output data processor 76. The output data processor 76 calculates output data representing signals for selectively turning on and off the micromirrors 40 of the DMDs 36 from the resolution-converted image data, and supplies the calculated output data to the output data corrector 78.

The output data corrector 78 reads the mask data set in step S11 from the mask data memory 82, corrects the on- and off-states of the micromirrors 40 that are represented by the output data, using the mask data, and supplies the corrected output data to the DMD controller 42. The DMD controller 42 energizes the DMDs 36 based on the corrected output data to selectively turn on and off the micromirrors 40.

The light source units 28a through 28j introduce the laser beams L, whose amounts of light have been adjusted by the light source controller 89, through the optical fibers 30 into the exposure heads 24a through 24j. The laser beams L are applied via the rod lenses 32 and the reflecting mirrors 34 to the DMDs 36. The laser beams L that are selectively reflected in desired directions by the micromirrors 40 of the DMDs 36 are magnified by the first image focusing optical lenses 44, 46, and then adjusted to a predetermined beam diameter by the microaperture arrays 54, the microlens arrays 48, and the microaperture arrays 56. Thereafter, the laser beams L are adjusted to a predetermined magnification by the second image focusing optical lenses 50, 52, and then guided to the substrate F. The exposure stage 18 moves along the bed 14, during which time a desired wiring pattern is recorded on the substrate F by the exposure heads 24a through 24j that are arrayed in the direction perpendicular to the direction in which the exposure stage 18 moves.

After the wiring pattern has been recorded on the substrate F, the substrate F is removed from the exposure apparatus 10, and then the developing process, the etching process, and the peeling process are performed on the substrate F. The amount of light of the laser beam L applied to the substrate F has been adjusted in view of the processes up to the final peeling process. Therefore, it is possible to obtain a highly accurate wiring pattern having a desired line width.

In the above embodiment, the test patterns 90 shown in FIG. 11 are recorded on the substrate F by way of exposure, and the amount-of-light correction variables for the laser beams L and the mask data are determined by measuring the line widths Wa(x) through Wj(x). However, amount-of-light correction variables and mask data may be determined by measuring space widths between adjacent ones of the test patterns 90. If it is difficult to measure the line widths Wa(x) through Wj(x) or the space widths highly accurately, then the densities of small areas established around the respective positions x of the test patterns 90 may be measured, and mask data may be determined from a distribution of the measured densities.

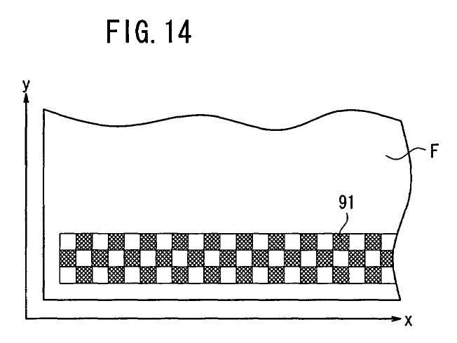

Instead of recording the test patterns 90 on the substrate F by way of exposure, as shown in FIG. 14, halftone dot patterns 91 having a predetermined halftone dot % may be recorded by way of exposure on the substrate F, and mask data may be determined by measuring halftone dot % or densities of the halftone dot patterns 91.

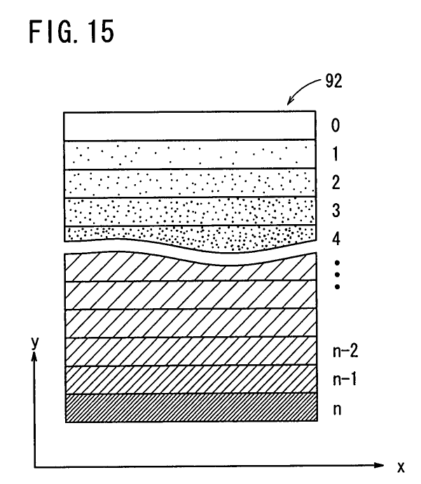

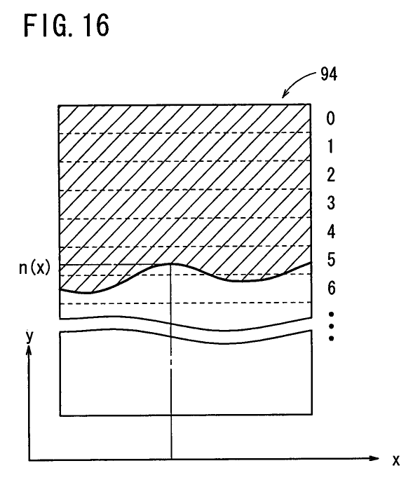

Gray scale data 92 in n (n=1, 2, . . . ) steps shown in FIG. 15 may be set as test data in the test data memory 80, and using the gray scale data 92, gray scale patterns for increasing amounts of light stepwise in the direction indicated by the arrow y on the substrate F may be recorded by way of exposure on the substrate F. Thereafter, the developing process, the etching process, and the peeling process may be performed on the substrate F, and then, as shown in FIG. 16, the range of copper foil patterns 94 remaining on the substrate F may be measured, the number n(x) of corresponding steps of the gray scale data 92 at the positions x on the copper foil patterns 94 may be determined, and mask data may be determined based on the number n(x).

In the above embodiment, the exposing process, the developing process, the etching process, and the peeling process are performed, and test patterns that are finally obtained are measured to determine mask data. However, test data may be measured as photoresist patterns after exposing process to determine mask data.

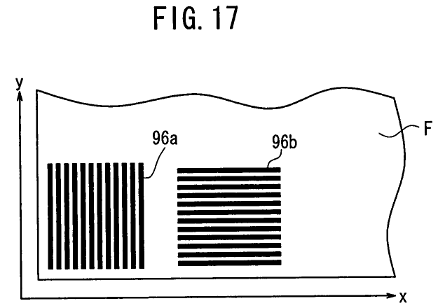

Alternatively, mask data may be determined by measuring the line widths or space widths of test patterns arrayed in two different directions, instead of the test patterns 90. For example, as shown in FIG. 17, a test pattern 96a of parallel bars along the scanning direction (the direction indicated by the arrow y) and a test pattern 96b of parallel bars along the line perpendicular to the scanning direction (the direction indicated by the arrow x) may be recorded in each position x on the substrate F, an amount-of-light correction variable may be calculated based on the average value of line widths of the test patterns 96a, 96b, and mask data may be determined. Using test patterns arranged in two different directions, it is possible to eliminate factors responsible for line width variations depending on the direction of the test patterns.

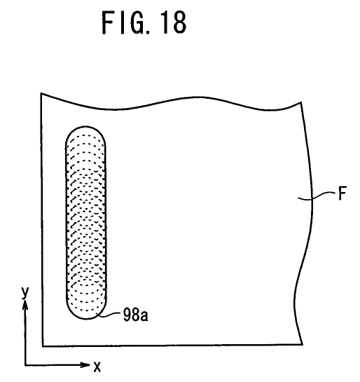

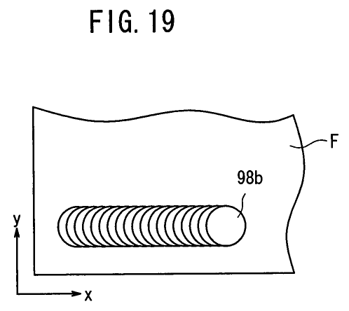

One factor that is responsible for varying the line widths may be that an edge of a test pattern is recorded differently in the scanning direction and the direction perpendicular to the scanning direction. Specifically, as shown in FIG. 18, an edge 98a of a test pattern in the direction in which the substrate F is scanned (the direction indicated by the arrow y), is recorded by a single spot or a plurality of spots of the laser beam L that move in the direction indicated by the arrow y, i.e., the direction in which the substrate F moves. On the other hand, as shown in FIG. 19, an edge 98b of a test pattern in the direction indicated by the arrow x is recorded by a plurality of spots of the laser beam L that do not move relatively to the substrate F. The difference as to how the edges 98a, 98b are recorded is possibly liable to develop different line widths. There is also a possibility of different line widths if the spots of the laser beam L are not of a circular shape.

Test patterns may be arranged in three or more directions, rather than the two directions described above. Test patterns that are inclined to the directions indicated by the arrows x, y may also be employed. A prescribed circuit pattern may be formed as a test pattern, and the circuit pattern may be measured to correct the amounts of light.

Alternatively, a plurality of mask data depending on the types of photosensitive materials that may be applied to the substrate F may be generated and stored in the mask data memory 82, and corresponding mask data may be selected according to the type of a photosensitive material used to adjust amounts of light and correct output data.

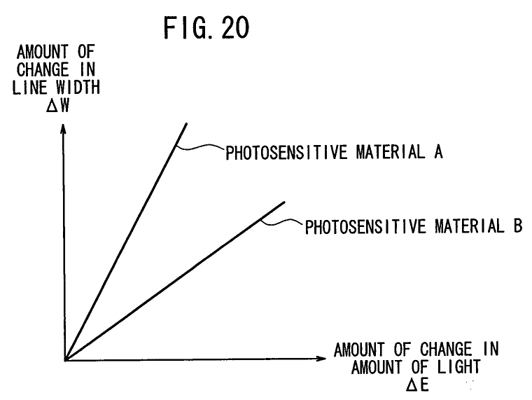

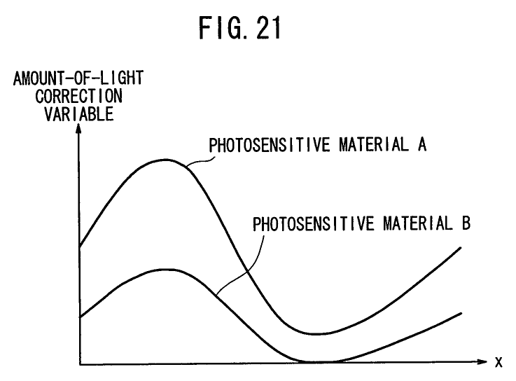

Specifically, as shown in FIG. 20, the relationship between an amount ΔE of change in the amount of light of the laser beam L applied to the substrate F and an amount ΔW of change in the line width, or the relationship between the amount of change in the beam diameter of the laser beam L and an amount ΔW of change in the line width, differs depending on the types of photosensitive materials A, B. The different relationships are caused by different gradation characteristics of the photosensitive materials A, B. As shown in FIG. 21, different line widths W may be produced even when a test pattern is recorded on the photosensitive materials A, B under the same conditions. In FIG. 20, the relationship between the amount ΔE of change in the amount of light and the amount ΔW of change in the line width is approximated by a straight line.

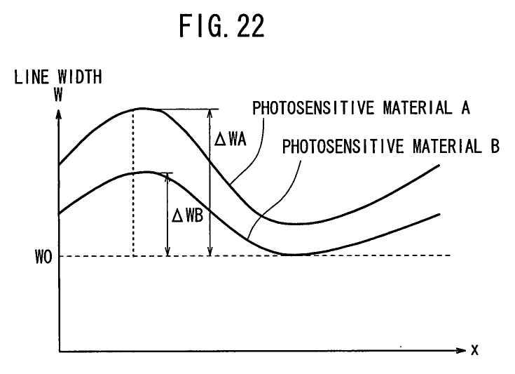

For recording patterns of the same line width regardless of the different characteristics of the photosensitive materials A, B, it is necessary to establish amount-of-light correction variables depending on the photosensitive materials A, B from the characteristic curves (FIG. 20) of the photosensitive materials A, B with respect to the relationship between the amount ΔE of change in the amount of light and the amount ΔW of change in the line width, and amounts of ΔWA, ΔWB (FIG. 21) of change in the line width from a reference line width W0 (e.g., a minimum value of the line width W) at each position x for the respective photosensitive materials A, B. FIG. 22 shows an example of amount-of-light correction variables established for the photosensitive materials A, B.

According to the present embodiment, the mask data setting unit 86 sets mask data based on the amount-of-light correction variables that are determined for the photosensitive materials A, B, and stores the established mask data in the mask data memory 82. For exposing the substrate F to a desired wiring pattern, mask data corresponding to the type of the photosensitive material entered by the operator are read from the mask data memory 82, and output data supplied from output data processor 76 are corrected by the mask data. In this manner, a highly accurate wiring pattern free of line width variations can be recorded on the substrate F independently of the type of the photosensitive material.

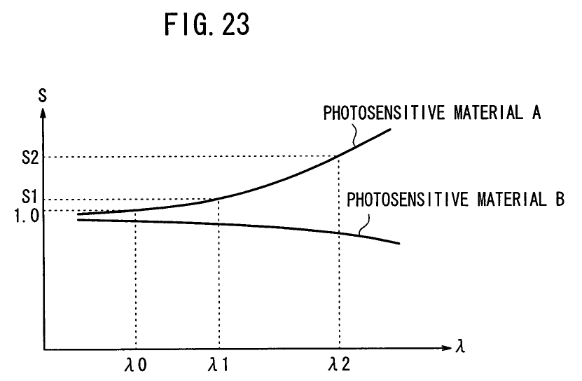

The relationship between the amount ΔE of change in the amount of light of the laser beam L applied to the substrate F and amount ΔW of change in the line width may be wavelength-dependent due to the spectral sensitivity characteristics of the photosensitive material. Though the same photosensitive material is used, the above relationship may differ depending on the wavelength of the laser beams L that are applied from the exposure heads 24a through 24j to the substrate F. FIG. 23 illustrates the characteristics of photosensitive materials A, B of two types which have different spectral sensitivity characteristics depending on the wavelength δ.

The wavelengths of the laser beams L applied to the substrate F are measured with respect to the respective exposure heads 24a through 24j, and the above relationship of each photosensitive material for the wavelengths is determined with respect to the respective exposure heads 24a through 24j in the amount-of-light/line width table memory 87. The relationship corresponding to the photosensitive material used is selected for each of the exposure heads 24a through 24j to set mask data, and the substrate F is exposed to a desired wiring pattern using the set mask data. By thus recording the wiring pattern, it is possible to form a highly accurate wiring pattern which is not affected by variations of the wavelengths of the laser beams L that are applied from the exposure heads 24a through 24j to the substrate F. Alternatively, the amounts of light of the laser beams L output from the exposure heads 24a through 24j may be adjusted by the light source controller 89 depending on the photosensitive material.

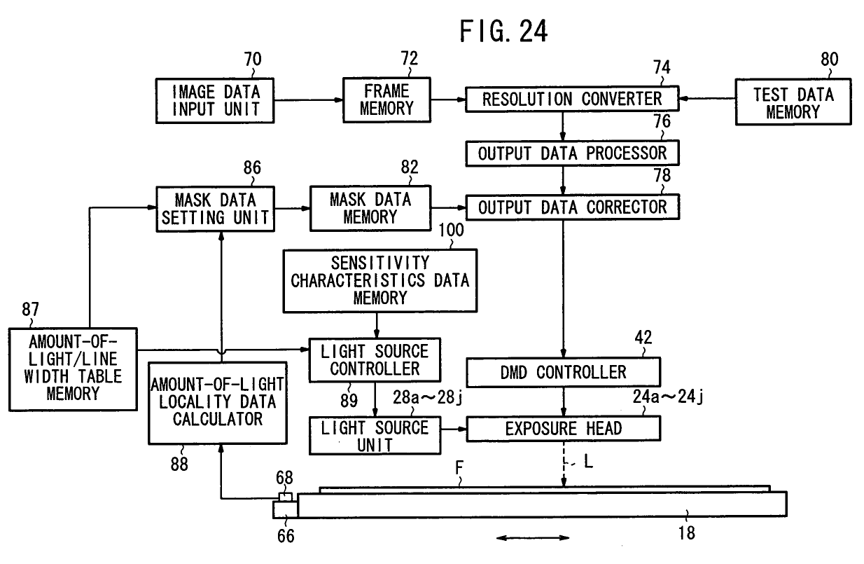

As shown in FIG. 24, the relationship between the wavelengths δ of the laser beams L and the spectral sensitivity characteristics S of the respective photosensitive materials for the wavelengths δ may be determined in advance and stored in a sensitivity characteristic data memory 100 (sensitivity characteristics storage means). The amounts of light of the laser beams L output from the light source units 28a through 28j may be adjusted using the spectral sensitivity characteristics.

Specifically, providing that the wavelengths δ of the laser beams L output from the exposure heads 24a through 24j are known, the spectral sensitivity characteristics S for the exposure heads 24a through 24j depending on the photosensitive material applied to the substrate F are read from the sensitivity characteristic data memory 100. Then, as shown in FIG. 23, for example, the spectral sensitivity characteristics S of the photosensitive material A at a reference wavelength δ0 are set to 1.0, and the reciprocals 1/S of the spectral sensitivity characteristics S for the exposure heads 24a through 24j are calculated as amount-of-light correction data. The reference wavelength δ0 is a wavelength for obtaining a desired line width when the test patterns 90 are recorded by the laser beam L having the reference wavelength δ0 and the reference amount E0 of light. The light source controller 89 adjusts the amounts of light of the laser beams L output from the light source units 28a through 28j according to the amount-of-light correction data 1/S for the exposure heads 24a through 24j depending on the photosensitive material.

For example, if the photosensitive material A of the spectral sensitivity characteristics shown in FIG. 23 is selected, then with respect to the light source units 28a through 28j which output laser beams L having a wavelength δl, the reference amount E0 of light of the reference wavelength δ0 that is set is corrected into E0/S1 based on amount-of-light correction data 1/S1 which represents the reciprocal of spectral sensitivity characteristics S1. With respect to the light source units 28a through 28j which output laser beams L having a wavelength δ2, the reference amount E0 of light that is set is corrected into E0/S2 based on amount-of-light correction data 1/S2.

Using the light source units 28a through 28j whose amounts of light have thus been adjusted, a wiring pattern having a desired line width can be recorded by way of exposure on the selected photosensitive material. The amounts of light of the laser beams L output from the exposure heads 24a through 24j can also be adjusted by setting mask data.

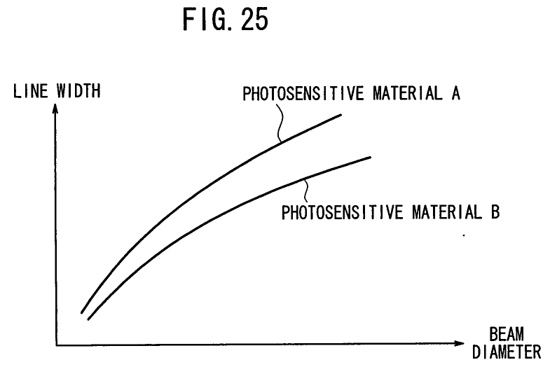

As shown in FIG. 25, the line width of the wiring pattern that is recorded by way of exposure on the substrate F is affected by the beam diameter of the laser beams L. This relationship differs depending on the gradation which is one of the sensitivity characteristics of the photosensitive material. For example, if the gradation varies, the density of the wiring pattern recorded on the substrate F and the film thickness of the photoresist 3 shown in FIG. 23 vary, resulting in a change in the line width.

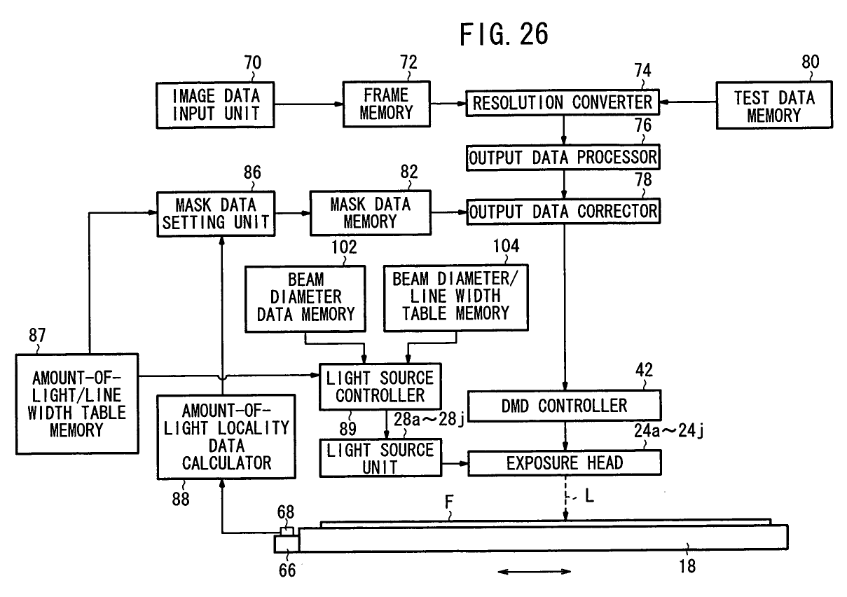

As shown in FIG. 26, the beam diameter of the laser beams L output from the exposure heads 24a through 24j is measured in advance and stored in a beam diameter data memory 102. The relationship between the beam diameter of the laser beams L and the line width with respect to the beam diameter for each of the photosensitive materials is determined in advance and stored in a beam diameter/line width table memory 104 (relationship storage means). Using the relationships, the amounts of light of the laser beams L output from the light source units 28a through 28j are adjusted.

Specifically, the beam diameter of the laser beams L output from the exposure heads 24a through 24j is read from the beam diameter data memory 102, and then line width with respect to the beam diameter for the exposure heads 24a through 24j depending on the photosensitive material applied to the substrate F is read from the beam diameter/line width table memory 104. Thereafter, the amounts of light of the laser beams L output from the light source units 28a through 28j are adjusted to set the line width to a desired line width. As a result, a wiring pattern having a desired line width can be recorded by way of exposure on the selected photosensitive material. The beam diameter for each of the exposure heads 24a through 24j may be measured instead of using the beam diameter stored in the beam diameter data memory 102. Alternatively, the amounts of light of the laser beams L output from the exposure heads 24a through 24j may be adjusted by setting mask data.

The exposure apparatus 10 may appropriately be used to expose a dry film resist (DFR) or a liquid resist in a process of manufacturing a multilayer printed wiring board (PWB), to form a color filter or a black matrix in a process of manufacturing a liquid crystal display (LCD), to expose a DFR in a process of manufacturing a TFT, and to expose a DFR in a process of manufacturing a plasma display panel (PDP), etc., for example. The present invention is also applicable to exposure apparatus for use in the field of printing and the field of photography.

1. A method of recording an image on an image recording medium by controlling a plurality of exposure heads, which have light sources for outputting light beams and are arrayed along the image recording medium, depending on image data, comprising the steps of:
controlling said exposure heads based on test data to record a test pattern on said image recording medium;
measuring recorded states of said test pattern recorded on said image recording medium respectively for said exposure heads;
correcting amounts of light of said light beams to equalize the recorded states of the image which is recorded on said image recording medium by said exposure heads, based on the relationship of amounts of change in the recorded states to amounts of change in the amounts of light of said light beams; and
controlling said exposure heads according to said image data to record the image on said image recording medium with the light beams whose amounts of light have been corrected.

2. A method according to claim 1, wherein said relationship is set depending on sensitivity characteristics of said image recording medium.

3. A method according to claim 2, wherein said image recording medium has spectral sensitivity characteristics representing different sensitivities depending on a wavelength of each of said light beams.

4. A method according to claim 1, wherein said test data comprise data for recording said test pattern which has a predetermined width or a predetermined interval on said image recording medium, and said recorded states represent the width or interval of said test pattern.

5. A method according to claim 1, wherein said test data comprise data for recording said test pattern which has a predetermined density on said image recording medium, and said recorded states represent the density of said test pattern.

6. A method according to claim 1, wherein said light sources of said exposure heads are adjusted to correct the amounts of light of said light beams.

7. A method according to claim 1, wherein said exposure heads comprise a spatial light modulator having a plurality of spatial light modulating elements for modulating said light beams according to said image data and guiding the modulated light beams to said image recording medium, and particular ones of said spatial light modulating elements of the spatial light modulator of said exposure heads are controlled into an off-state to correct the amounts of light of said light beams.

8. A method according to claim 1, comprising the step of:
correcting the amounts of light of said light beams based on said relationship for making constant the recorded states of the image recorded by said exposure heads irrespective of the position within said exposure heads.

9. A method of adjusting an amount of light in recording an image on an image recording medium by controlling a plurality of exposure heads, which have light sources for outputting light beams and are arrayed along the image recording medium, depending on image data, comprising the steps of:
controlling said exposure heads based on test data to record a test pattern on said image recording medium;
measuring recorded states of said test pattern recorded on said image recording medium respectively for said exposure heads; and
adjusting amounts of light of said light beams to equalize the recorded states of the test pattern which is recorded on said image recording medium by said exposure heads, based on the relationship of amounts of change in the recorded states to amounts of change in the amounts of light of said light beams.

10. An apparatus for recording an image on an image recording medium by controlling a plurality of exposure heads, which have light sources for outputting light beams and are arrayed along the image recording medium, depending on image data, comprising:
test data storage means for storing test data for recording a test pattern on said image recording medium;
relationship storage means for storing the relationship of amounts of change in recorded states of said test pattern on said image recording medium to amounts of change in amounts of light of said light beams;
amount-of-light correcting means for correcting the amounts of light of said light beams based on said relationship for equalizing the recorded states of the image which is recorded on said image recording medium by said exposure heads; and
exposure head control means for controlling said exposure heads according to said image data to record the image on said image recording medium with the light beams whose amounts of light have been corrected.

11. An apparatus according to claim 10, wherein said relationship storage means stores said relationship depending on sensitivity characteristics of said image recording medium.

12. An apparatus according to claim 10, wherein said image recording medium has spectral sensitivity characteristics representing different sensitivities depending on a wavelength of each of said light beams.

13. An apparatus according to claim 10, wherein said relationship storage means stores said relationship according to spectral sensitivity characteristics representing different sensitivities depending on a wavelength of each of said light beams.

14. An apparatus according to claim 10, wherein said test data comprise data for recording said test pattern which has a predetermined width or a predetermined interval on said image recording medium, and said recorded states represent the width or interval of said test pattern.

15. An apparatus according to claim 10, wherein said test data comprise data for recording said test pattern which has a predetermined density on said image recording medium, and said recorded states represent the density of said test pattern.

16. An apparatus according to claim 10, wherein said amount-of-light correcting means adjusts said light sources of said exposure heads to correct the amounts of light of said light beams.

17. An apparatus according to claim 10, wherein said exposure heads comprise a spatial light modulator having a plurality of spatial light modulating elements for modulating said light beams according to said image data and guiding the modulated light beams to said image recording medium, and said amount-of-light correcting means controls particular ones of said spatial light modulating elements of the spatial light modulator of said exposure heads into an off-state to correct the amounts of light of said light beams.

18. An apparatus according to claim 17, wherein said spatial light modulator comprises a micromirror device including a two-dimensional array of micromirrors having reflecting surfaces for reflecting said light beam, said reflecting surfaces being angularly variable depending on said image data.

19. An apparatus according to claim 10, wherein said light sources comprise semiconductor lasers.

20. An apparatus according to claim 10, further comprising second amount-of-light correcting means for correcting the amounts of light of said light beams based on said relationship for making constant the recorded states of the image recorded by said exposure heads irrespective of the position within said exposure heads.

21. A method of recording an image on an image recording medium by controlling a plurality of exposure heads, which have light sources for outputting light beams and are arrayed along the image recording medium (depending on image data, comprising the steps of:
correcting amounts of light of said light beams to adjust recorded states of an image which is recorded on said image recording medium by said exposure heads, based on sensitivity characteristics of said image recording medium with respect to wavelengths of said light beams guided from said exposure heads to said image recording medium; and
controlling said exposure heads according to said image data to record the image on said image recording medium with the light beams whose amounts of light have been corrected.

22. A method according to claim 21, wherein said image recording medium has spectral sensitivity characteristics representing different sensitivities depending on the wavelengths of said light beams.

23. A method according to claim 21, wherein said light sources of said exposure heads are adjusted to correct the amounts of light of said light beams.

24. A method according to claim 21, wherein said exposure heads comprise a spatial light modulator having a plurality of spatial light modulating elements for modulating said light beams according to said image data and guiding the modulated light beams to said image recording medium, and particular ones of said spatial light modulating elements of the spatial light modulator of said exposure heads are controlled into an off-state to correct the amounts of light of said light beams.

25. A method of adjusting an amount of light in recording an image on an image recording medium by controlling a plurality of exposure heads, which have light sources for outputting light beams and are arrayed along the image recording medium, depending on image data, comprising the step of
adjusting amounts of light of said light beams to adjust recorded states of an image which is recorded on said image recording medium by said exposure heads, based on sensitivity characteristics of said image recording medium with respect to wavelengths of said light beams guided from said exposure heads to said image recording medium.

26. An apparatus for recording an image on an image recording medium by controlling a plurality of exposure heads, which have light sources for outputting light beams and are arrayed along the image recording medium, depending on image data, comprising:
sensitivity characteristics storage means for storing sensitivity characteristics of said image recording medium with respect to wavelengths of said light beams;
amount-of-light correcting means for correcting amounts of light of said light beams to adjust recorded states of the image which is recorded on said image recording medium by said exposure heads, based on said sensitivity characteristics with respect to the wavelengths of said light beams guided from said exposure heads to said image recording medium; and
exposure head control means for controlling said exposure heads according to said image data to record the image on said image recording medium with the light beams whose amounts of light have been corrected.

27. An apparatus according to claim 26, wherein said sensitivity characteristics storage means store spectral sensitivity characteristics representing different sensitivities depending on the wavelengths of said light beams.

28. An apparatus according to claim 26, wherein amount-of-light correcting means adjusts said light sources of said exposure heads to correct the amounts of light of said light beams.

29. An apparatus according to claim 26, wherein said exposure heads comprise a spatial light modulator having a plurality of spatial light modulating elements for modulating said light beams according to said image data and guiding the modulated light beams to said image recording medium, and said amount-of-light correcting means controls particular ones of said spatial light modulating elements of the spatial light modulator of said exposure heads into an off-state to correct the amounts of light of said light beams.

30. A method of recording an image on an image recording medium by controlling a plurality of exposure heads, which have light sources for outputting light beams and are arrayed along the image recording medium, depending on image data, comprising the steps of:
acquiring beam diameters of said light beams guided from said exposure heads to said image recording medium with respect to said exposure heads;
correcting amounts of light of said light beams to adjust recorded states of the image which is recorded on said image recording medium by said exposure heads, based on the relationship of recorded states of the image which is recorded on said image recording medium by said exposure heads to the beam diameters of said light beams; and
controlling said exposure heads according to said image data to record the image on said image recording medium with the light beams whose amounts of light have been corrected.

31. A method according to claim 30, wherein said relationship is set depending on sensitivity characteristics of said image recording medium.

32. A method according to claim 31, wherein said image recording medium has spectral sensitivity characteristics representing different sensitivities depending on a wavelength of said light beams.

33. A method according to claim 30, wherein said light sources of said exposure heads are adjusted to correct the amounts of light of said light beams.

34. A method according to claim 30, wherein said exposure heads comprise a spatial light modulator having a plurality of spatial light modulating elements for modulating said light beams according to said image data and guiding the modulated light beams to said image recording medium, and particular ones of said spatial light modulating elements of the spatial light modulator of said exposure heads are controlled into an off-state to correct the amounts of light of said light beams.

35. A method according to claim 30, comprising the step of
correcting the amounts of light of said light beams based on said relationship for making constant the recorded states of the image recorded by said exposure heads irrespective of the position within said exposure heads.

36. A method of adjusting an amount of light in recording an image on an image recording medium by controlling a plurality of exposure heads, which have light sources for outputting light beams and are arrayed along the image recording medium, depending on image data, comprising the steps of:
acquiring beam diameters of said light beams guided from said exposure heads to said image recording medium with respect to said exposure heads; and
adjusting amounts of light of said light beams to adjust recorded states of the image which is recorded on said image recording medium by said exposure heads, based on a relationship of the recorded states of the image which is recorded on said image recording medium by said exposure heads to the beam diameters of said light beams.

37. An apparatus for recording an image on an image recording medium by controlling a plurality of exposure heads, which have light sources for outputting light beams and are arrayed along the image recording medium 3 depending on image data, comprising:
relationship storage means for storing the relationship of recorded states of the image which is recorded on said image recording medium to beam diameters of said light beams;
amount-of-light correcting means for acquiring the beam diameters of said light beams guided from said exposure heads to said image recording medium with respect to said exposure heads, and correcting amounts of light of said light beams to adjust the recorded states of the image which is recorded on said image recording medium by said exposure heads, based on said relationship; and
exposure head control means for controlling said exposure heads according to said image data to record the image on said image recording medium with the light beams whose amounts of light have been corrected.

38. An apparatus according to claim 37, wherein said relationship storage means stores said relationship depending on sensitivity characteristics of said image recording medium.

39. An apparatus according to claim 37, wherein said amount-of-light correcting means adjusts said light sources of said exposure heads to correct the amounts of light of said light beams.

40. An apparatus according to claim 37, wherein said exposure heads comprise a spatial light modulator having a plurality of spatial light modulating elements for modulating said light beams according to said image data and guiding the modulated light beams to said image recording medium, and said amount-of-light correcting means controls particular ones of said spatial light modulating elements of the spatial light modulator of said exposure heads into an off-state to correct the amounts of light of said light beams.

41. An apparatus according to claim 37, further comprising second amount-of-light correcting means for correcting the amounts of light of said light beams based on said relationship for making constant the recorded states of the image recorded by said exposure heads irrespective of the position within said exposure heads.
